(19) United States
(12) Patent Application Publication
(10) Pub. No.: US 2023/0099741 A1
(43) Pub. Date: Mar. 30, 2023

(54) CONNECTOR

(71) Applicant: TOGO SEISAKUSYO CORPORATION, Aichi-gun, Aichi (JP)

(72) Inventors: Shigeo OI, Aichi-gun, Aichi (JP); Yuya KIDO, Aichi-gun, Aichi (JP); Shohei HOSOKAWA, Aichi-gun, Aichi (JP)

(21) Appl. No.: 17/802,181

(22) PCT Filed: Jan. 26, 2021
(86) PCT No.: PCT/JP2021/002591

§ 371 Date: Aug. 25, 2022

(30) Foreign Application Priority Data
Feb. 28, 2020 (JP) 2020-033866

(51) Int. Cl. F16L 37/084

(52) U.S. Cl. CPC F16L 37/0841

(57) ABSTRACT

Provided is a connector to be connected to a first pipe including a bulged portion. The connector includes a retainer. The retainer is movable between a standby position and a restraining position. The retainer includes a locking leg and a biasing leg. The locking leg includes a locking part to be locked to a connector body when the retainer is in the standby position and when the retainer is in the restraining position. The locking leg moves radially outward by contacting with the bulged portion, to thereby release locking of the locking part. The biasing leg is elastically deformed radially outward by contacting with a leading end portion of the first pipe, which is located on a leading end side with respect to the bulged portion, to thereby bias the retainer in a direction toward the restraining position.

### CROSS-REFERENCE TO RELATED APPLICATIONS

This patent application claims priority from PCT Patent Application No. PCT/JP2021/002591 filed Jan. 26, 2021, which claims priority from Japanese Patent Application No. JP2020-033866 filed Feb. 28, 2020. Each of these patent applications are herein incorporated by reference in their entirety.

### TECHNICAL FIELD

The present disclosure relates to a connector.

### BACKGROUND ART

Patent Document 1 discloses a connector. The connector comprises a connector body and a retainer. The connector is to be connected to a first pipe having a bulged portion, and is also to be connected to a second pipe. The retainer is movable between a standby position and a restraining position. The retainer comprises elastic pieces and locking pieces. The standby position is a position in which the first pipe is allowed to be inserted into an insertion hole and to be detached from the insertion hole. The restraining position is a position in which the connected first pipe is restrained from being detached from the insertion hole.

When the retainer is in the standby position, the retainer is locked to the connector body by the locking pieces. When the retainer is in the standby position, insertion of the first pipe into the insertion hole of the connector causes the bulged portion of the first pipe to push the elastic pieces to spread them outward. The elastic pieces pushed to spread outward bias the retainer in a direction toward the restraining position.

Further, when the elastic pieces are pushed to spread, the locking pieces are also pushed to spread outward concurrently in a linked manner. When the locking pieces are pushed to spread outward, locking by the locking pieces is released. When locking by the locking pieces is released, a biasing force generated by the elastic pieces moves the retainer to the restraining position.

### PRIOR ART DOCUMENTS

### Patent Documents

Patent Document 1: Patent Gazette No. U.S. Pat. No. 5,518,522

### SUMMARY OF THE INVENTION

### Problems to be Solved by the Invention

In the connector disclosed in Patent Document 1, the bulged portion of the first pipe pushes the elastic pieces and the locking pieces to spread them outward concurrently. Thus, when locking by the locking pieces is released, a sufficient biasing force is not applied to the retainer in some cases. If a sufficient biasing force is not applied to the retainer, it is difficult for the retainer to move to the restraining position.

In one aspect of the present disclosure, it is desirable to provide a connector in which, when a pipe is connected to the connector, a retainer is easily moved to a restraining position.

### Means for Solving the Problems

One aspect of the present disclosure is a connector that comprises a connector body and a retainer, and that is configured to be connected to a first pipe comprising a bulged portion and to a second pipe. The connector body comprises an insertion hole into which the first pipe is inserted from one side, and an opening communicating with the insertion hole.

The retainer is configured to be movable between a standby position in which the first pipe is allowed to be inserted into the insertion hole and to be detached from the insertion hole and a restraining position in which the first pipe connected is restrained from being detached from the insertion hole.

The retainer comprises a locking leg to be inserted inside the connector body through the opening, a biasing leg to be inserted inside the connector body through the opening, and a restraining part configured to, when the first pipe is connected to the connector and the retainer is in the restraining position, restrain detachment of the first pipe from the insertion hole by contacting with the bulged portion from the one side.

The locking leg comprises a locking part to be locked to the connector body when the retainer is in the standby position and when the retainer is in the restraining position. The locking leg is configured to, when the retainer is in the standby position and the first pipe is inserted into the insertion hole, move outward in a radial direction of the first pipe by contacting with the bulged portion, to thereby release locking of the locking part.

The biasing leg is configured to, when the retainer is in the standby position and the first pipe is inserted into the insertion hole, be elastically deformed outward in the radial direction of the first pipe by contacting with a leading end portion of the first pipe, which is located on a leading end side with respect to the bulged portion, before the locking leg comes in contact with the bulged portion, to thereby bias the retainer in a direction toward the restraining position.

The connector in one aspect of the present disclosure is configured such that, in the state in which the retainer is biased in the direction toward the restraining position, locking of the locking part is released, and the retainer is moved to the restraining position. Thus, when the first pipe is connected to the connector, the retainer is easily moved to the restraining position.

### BRIEF DESCRIPTION OF THE DRAWINGS

FIG. 1 is a perspective view showing a configuration of a connector.

FIG. 2 is a perspective view showing the connector with a first pipe connected thereto.

FIG. 3 is an explanatory diagram showing a configuration of a lock body as viewed from a viewpoint on the side of a leftward direction L.

FIG. 4 is an explanatory diagram showing the configuration of the lock body as viewed from a viewpoint on the side of an upward direction U.

FIG. 5 is an explanatory diagram showing the configuration of the lock body as viewed from a viewpoint on the side of a downward direction D.

FIG. 6 is an explanatory diagram showing the configuration of the lock body as viewed from a viewpoint on the side of an axially forward direction F.

FIG. 7 is an explanatory diagram showing the configuration of the lock body as viewed from a viewpoint on the side of an axially backward direction B.

FIG. 8 is a sectional view at a VIII-VIII section in FIG. 3.

FIG. 9 is a sectional view at a IX-IX section in FIG. 3.

FIG. 10 is an explanatory diagram showing a configuration of a retainer as viewed from a viewpoint on the side of the leftward direction L.

FIG. 11 is an explanatory diagram showing the configuration of the retainer as viewed from a viewpoint on the side of the upward direction U.

FIG. 12 is an explanatory diagram showing the configuration of the retainer as viewed from a viewpoint on the side of the downward direction D.

FIG. 13 is an explanatory diagram showing the configuration of the retainer as viewed from a viewpoint on the side of the axially forward direction F.

FIG. 14 is an explanatory diagram showing the configuration of the retainer as viewed from a viewpoint on the side of the axially backward direction B.

FIG. 15 is an explanatory diagram showing a configuration of a connecting portion as viewed from a viewpoint on the side of the leftward direction L.

FIG. 16 is an explanatory diagram showing a configuration of a first pipe as viewed from a viewpoint on the side of the leftward direction L.

FIG. 17 is an explanatory diagram showing locking legs at the time when the retainer is moved to a standby position.

FIG. 18 is an explanatory diagram showing biasing legs at the time when the retainer is moved to the standby position.

FIG. 19 is an explanatory diagram showing the locking legs at the time when the retainer is moved from the standby position to a restraining position.

FIG. 20 is an explanatory diagram showing the biasing legs at the time when the retainer is moved from the standby position to the restraining position.

FIG. 21 is an explanatory diagram showing a configuration of a retainer in a second embodiment, as viewed from a viewpoint on the side of the axially forward direction F.

FIG. 22 is a sectional view showing the connector with the first pipe connected thereto.

### EXPLANATION OF REFERENCE NUMERALS

1 . . . connector, 3 . . . first pipe, 5 . . . second pipe, 5A . . . end, 7 . . . lock body, 9 . . . connecting portion, 11 . . . retainer, 13 . . . insertion hole, 15 . . . opening, 17 . . . through hole, 19 . . . leading end, 21 . . . bulged portion, 23 . . . leading end portion, 25, 27, 29, 31, 33, 35 . . . wall portion, 29A, 31A . . . inner peripheral surface, 37, 39 . . . hole, 37A, 39A . . . end face, 41 . . . stepped part, 42, 44 . . . rib, 43 . . . end face, 45, 47, 49, 51 . . . opening, 53, 55, 57, 59 . . . groove, 53A, 55A, 57A, 59A . . . main part, 53B, 55B, 57B, 59B . . . first body-side locking part, 53C, 55C, 57C, 59C . . . second body-side locking part, 53D, 55D, 57D, 59D . . . edge part, 61 . . . intermediate portion, 63 . . . base portion, 65 . . . leading end portion, 67 . . . protrusion, 71 . . . base portion, 73, 75 . . . locking leg, 77, 79 . . . biasing leg, 81 . . . lower end part, 83, 85 . . . protrusion, 87 . . . beveled protrusion, 87A . . . inclined surface, 89 . . . restraining part, 91 . . . inclined surface, 93 . . . restraining plate, 95, 97 . . . restraining part, 95A, 97A . . . end face, 99 . . . central part, 101 . . . step, 103 . . . O-ring

### MODE FOR CARRYING OUT THE INVENTION

Example embodiments of the present disclosure will be described with reference to the drawings.

### First Embodiment

### 1. Configuration of Connector 1

(1-1) Overall Configuration of Connector 1

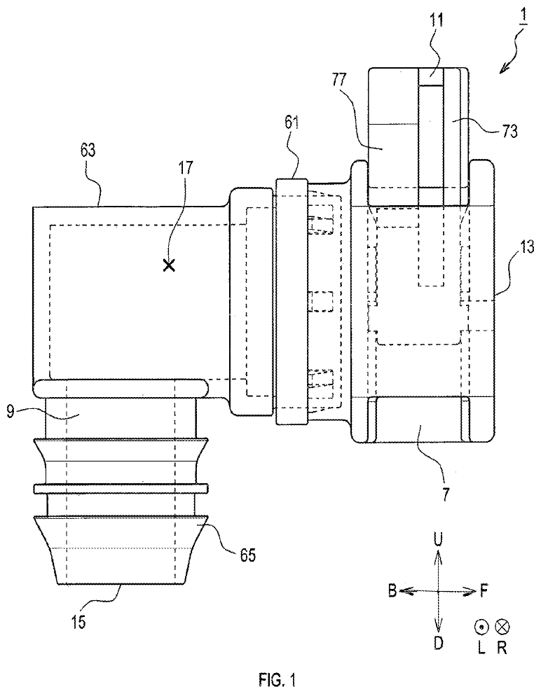

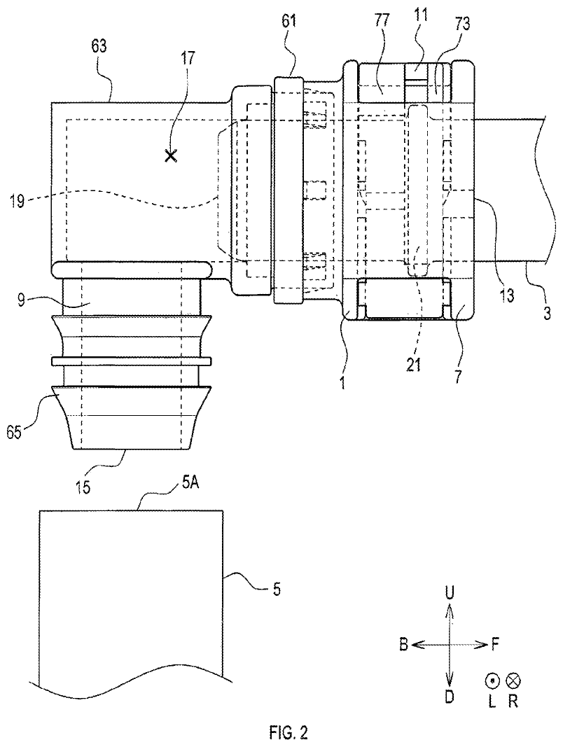

An overall configuration of a connector 1 will be described based on FIGS. 1 and 2. As shown in FIG. 2, the connector 1 is connected to a first pipe 3. The connector 1 is also to be connected to a second pipe 5. The first pipe 3 is, for example, a metal pipe. Examples of the first pipe 3 include a cooling water pipe in an engine room of a vehicle. Examples of the second pipe 5 include a resin tube.

Hereafter, a leftward direction in FIGS. 1 and 2 is referred to as an axially backward direction B, and a rightward direction in FIGS. 1 and 2 is referred to as an axially forward direction F. Also, an upward direction in FIGS. 1 and 2 is referred to as an upward direction U, and a downward direction in FIGS. 1 and 2 is referred to as a downward direction D. Also, a front direction in FIGS. 1 and 2 is referred to as a leftward direction L, and a depth direction in FIGS. 1 and 2 is referred to as a rightward direction R.

The connector 1 comprises a lock body 7, a connecting portion 9, and a retainer 11. The lock body 7 and the connecting portion 9 correspond to a connector body. The lock body 7 is located on the side of the axially forward direction F in the connector 1. The lock body 7 is connected to the first pipe 3 together with the retainer 11. The lock body 7 contains an insertion hole 13 at an end on the side of the axially forward direction F. When connecting the first pipe 3 to the connector 1, the first pipe 3 is inserted into the insertion hole 13 from the side of the axially forward direction F. The side of the axially forward direction F corresponds to one side.

The connecting portion 9 is located on the side of the axially backward direction B in the connector 1. The connecting portion 9 is connected to the lock body 7.

The connector 1 contains thereinside a through hole 17. The through hole 17 extends from a leading end 19 of the connected first pipe 3 to the connecting portion 9. Thus, when the first pipe 3 and the second pipe 5 are connected to the connector 1, the inside of the first pipe 3 communicates with the inside of the second pipe 5 via the through hole 17.

(1-2) Configuration of First Pipe 3

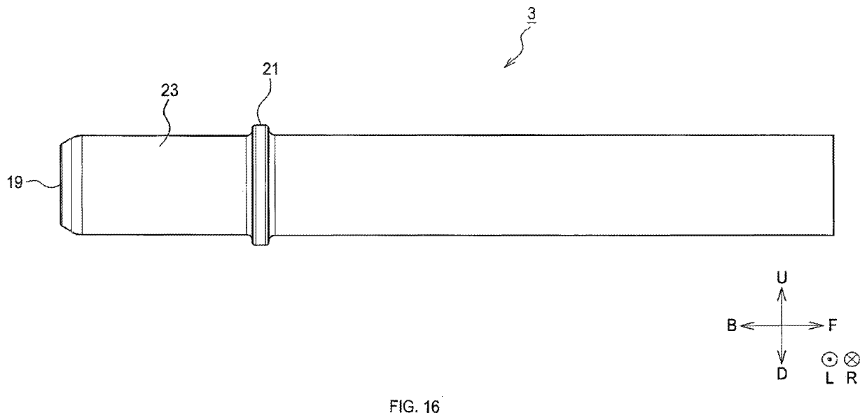

A configuration of the first pipe 3 will be described based on FIG. 16. The first pipe 3 has a basic form shaped like a hollow cylinder. The first pipe 3 is open at the leading end 19. The first pipe 3 is also open at an end opposite the leading end 19.

The first pipe 3 comprises a bulged portion 21 at a position apart from the leading end 19 in the axially forward direction F. Descriptions of the directions relating to the first pipe 3 indicate the directions in the case where the first pipe 3 is connected to the connector 1.

The outside diameter of the bulged portion 21 is referred to as d1. The outside diameter of the first pipe 3 is constant in places other than where the bulged portion 21 is. The outside diameter in the places other than where the bulged portion 21 is, is referred to as d2. d1 is greater than d2. A portion of the first pipe 3 located on the side of the leading end 19 with respect to the bulged portion 21 is referred to as a leading end portion 23. The outside diameter of the leading end portion 23 is d2.

(1-3) Configuration of Lock Body 7

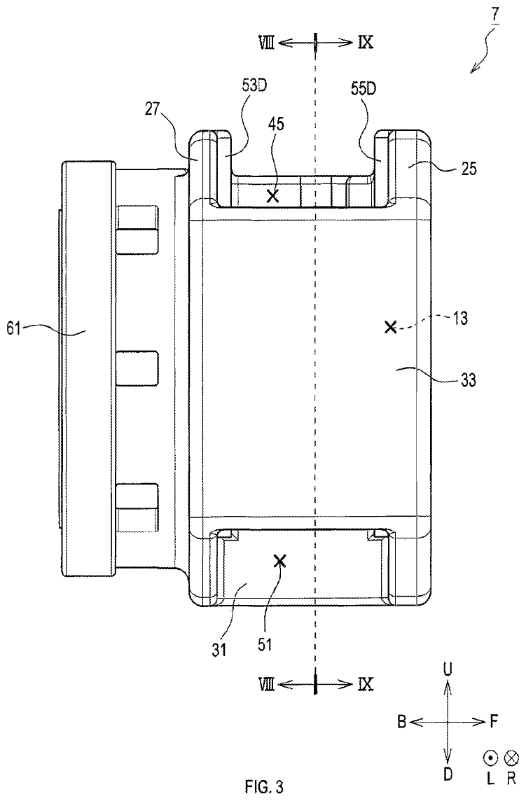

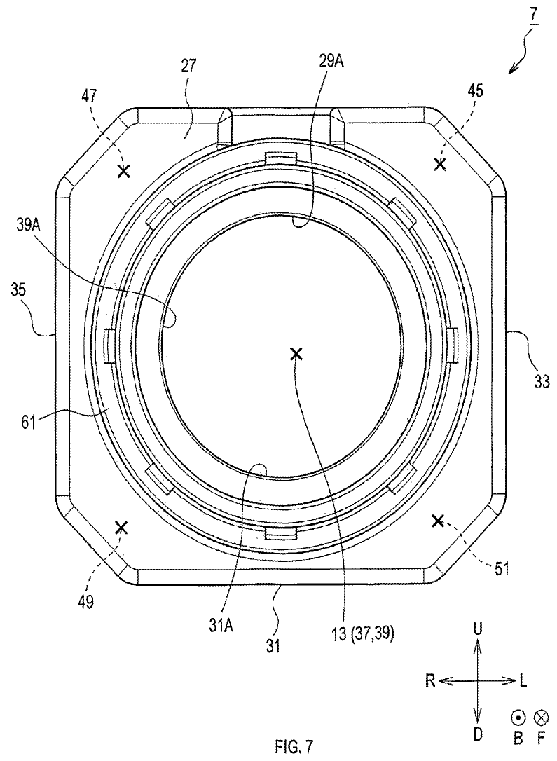

A configuration of the lock body 7 will be described based on FIGS. 3 to 9 and 22. The lock body 7 has a basic form shaped like a hollow box. The basic form shaped like a hollow box is configured with wall portions 25, 27, 29, 31, 33, 35.

The wall portion 25 is located on the side of the axially forward direction F in the lock body 7. A thickness direction of the wall portion 25 is parallel to the axially forward direction F. The wall portion 27 is located on the side of the axially backward direction B in the lock body 7. A thickness direction of the wall portion 27 is parallel to the axially backward direction B.

The wall portion 29 is located on the side of the upward direction U in the lock body 7. A thickness direction of the wall portion 29 is parallel to the upward direction U. The wall portion 31 is located on the side of the downward direction D in the lock body 7. A thickness direction of the wall portion 31 is parallel to the downward direction D.

The wall portion 33 is located on the side of the leftward direction L in the lock body 7. A thickness direction of the wall portion 33 is parallel to the leftward direction L. The wall portion 35 is located on the side of the rightward direction R in the lock body 7. A thickness direction of the wall portion 35 is parallel to the rightward direction R.

An inner peripheral surface of the insertion hole 13 is configured with an end face 37A of a hole 37 of a circular shape formed in the wall portion 25, an end face 39A of a hole 39 of a circular shape formed in the wall portion 27, an inner peripheral surface 29A of the wall portion 29, and an inner peripheral surface 31A of the wall portion 31. The inner peripheral surface 29A and the inner peripheral surface 31A each have an arc shape as viewed from a viewpoint on the side of the axially forward direction F.

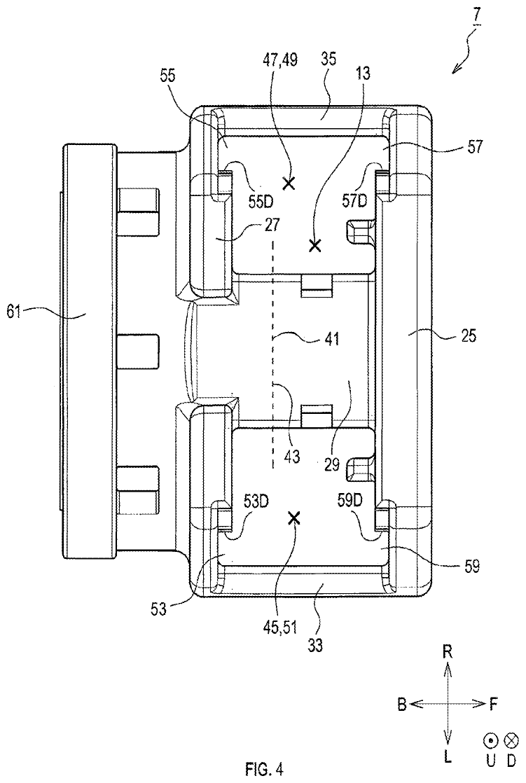

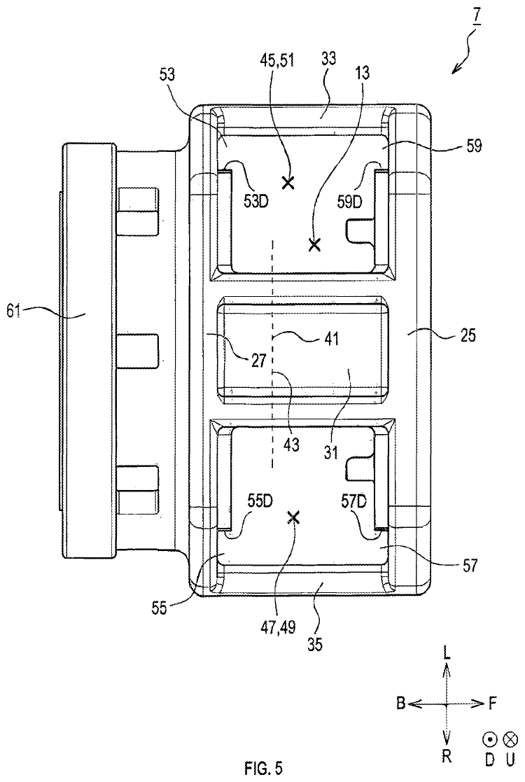

The inside diameter of the insertion hole 13 is slightly greater than d2 and smaller than d1 in a part on the side of the axially backward direction B with respect to a stepped part 41 shown in FIGS. 4 and 5. The inside diameter of the insertion hole 13 is slightly greater than d1 in a part on the side of the axially forward direction F with respect to the stepped part 41.

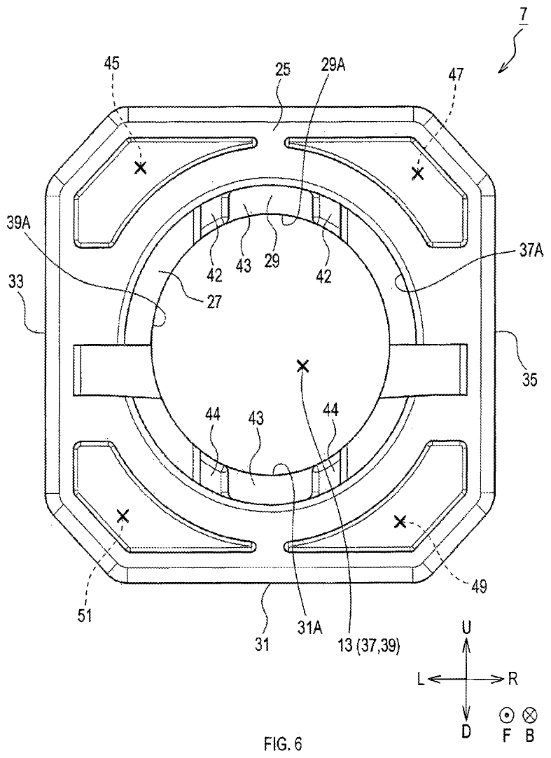

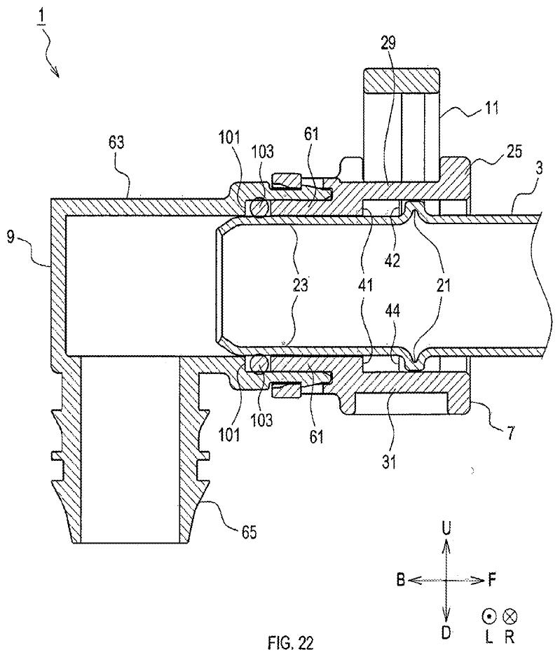

The inside diameter of the inner peripheral surface 29A and the inner peripheral surface 31A is smaller in the part on the side of the axially backward direction B with respect to the stepped part 41 than in the part on the side of the axially forward direction F with respect to the stepped part 41. This results in generating a step at the stepped part 41 on the inner peripheral surface 29A and the inner peripheral surface 31A. As shown in FIG. 6, an end face 43 of the stepped part 41 is perpendicular to the axially backward direction B and to the axially forward direction F. On the inner peripheral surface 29A, a rib 42 shown in FIGS. 6 and 22 is formed on the side of the axially forward direction F with respect to the stepped part 41. Further, on the inner peripheral surface 31A, a rib 44 shown in FIGS. 6 and 22 is formed on the side of the axially forward direction F with respect to the stepped part 41.

The lock body 7 includes openings 45, 47, 49, 51. The openings 45, 47, 49, 51 each allow for communication between the inside and the outside of the lock body 7. The openings 45, 47, 49, 51 each communicate with the insertion hole 13.

The opening 45 is present between the wall portion 29 and the wall portion 33. The opening 47 is present between the wall portion 29 and the wall portion 35. The opening 49 is present between the wall portion 31 and the wall portion 35. The opening 51 is present between the wall portion 31 and the wall portion 33.

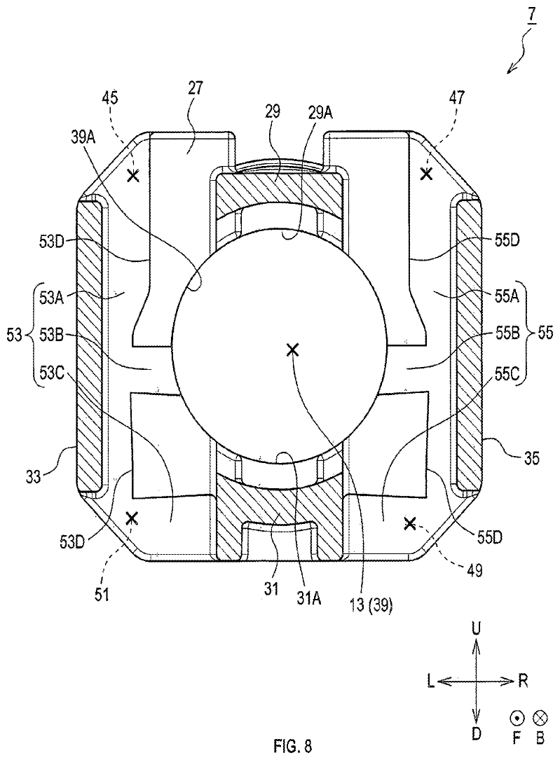

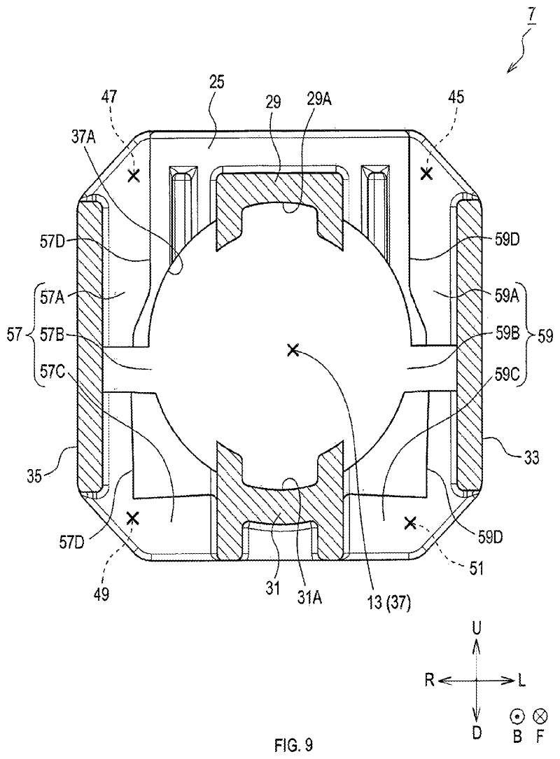

As shown in FIG. 4, the opening 45 and the opening 47 are side by side along the leftward direction L and the rightward direction R. The wall portion 29 is present between the opening 45 and the opening 47. As shown in FIGS. 8 and 9, the opening 45 and the opening 51 are side by side along the upward direction U and the downward direction D. Further, the opening 47 and the opening 49 are side by side along the upward direction U and the downward direction D.

As shown in FIG. 8, grooves 53, 55 are formed on an inner surface of the wall portion 27. The grooves 53, 55 are formed by making the thickness of the wall portion 27 thinner than their surroundings. The groove 53 comprises a main part 53A extending along the wall portion 33, a first body-side locking part 53B extending in the rightward direction R from around the center of the main part 53A, and a second body-side locking part 53C extending in the rightward direction R from a lower end of the main part 53A.

An edge part of the main part 53A on the side of the rightward direction R is assigned with 53D. A position of the edge part 53D, on an upper side than the first body-side locking part 53B, is gradually displaced in the leftward direction L as approaching the first body-side locking part 53B, and when reaching the first body-side locking part 53B, the position is located on a frontmost side in the leftward direction L. A position of the edge part 53D, on a lower side than the first body-side locking part 53B, is located on the frontmost side in the leftward direction L.

The groove 55 comprises a main part 55A extending along the wall portion 35, a first body-side locking part 55B extending in the leftward direction L from around the center of the main part 55A, and a second body-side locking part 55C extending in the leftward direction L from a lower end of the main part 55A.

An edge part of the main part 55A on the side of the leftward direction L is assigned with 55D. A position of the edge part 55D, on an upper side than the first body-side locking part 55B, is gradually displaced in the rightward direction R as approaching the first body-side locking part 55B, and when reaching the first body-side locking part 55B, the position is located on a frontmost side in the rightward direction R. A position of the edge part 55D, on a lower side than the first body-side locking part 55B, is located on the frontmost side in the rightward direction R.

As shown in FIG. 9, grooves 57, 59 are formed on an inner surface of the wall portion 25. The grooves 57, 59 are configured by making the thickness of the wall portion 25 thinner than their surroundings. The groove 57 comprises a main part 57A extending along the wall portion 35, a first body-side locking part 57B extending in the leftward direction L from around the center of the main part 57A, and a second body-side locking part 57C extending in the leftward direction L from a lower end of the main part 57A.

An edge part of the main part 57A on the side of the leftward direction L is assigned with 57D. A position of the edge part 57D, on an upper side than the first body-side locking part 57B, is gradually displaced in the rightward direction R as approaching the first body-side locking part 57B, and when reaching the first body-side locking part 57B, the position is located on a frontmost side in the rightward direction R. A position of the edge part 57D, on a lower side than the first body-side locking part 57B, is located on the frontmost side in the rightward direction R.

The groove 59 comprises a main part 59A extending along the wall portion 33, a first body-side locking part 59B extending in the rightward direction R from around the center of the main part 59A, and a second body-side locking part 59C extending in the rightward direction R from a lower end of the main part 59A.

An edge part of the main part 59A on the side of the rightward direction R is assigned with 59D. A position of the edge part 59D, on an upper side than the first body-side locking part 59B, is gradually displaced in the leftward direction L as approaching the first body-side locking part 59B, and when reaching the first body-side locking part 59B, the position is located on a frontmost side in the leftward direction L. A position of the edge part 59D, on a lower side than the first body-side locking part 59B, is located on the frontmost side in the leftward direction L.

The lock body 7 comprises an intermediate portion 61. The intermediate portion 61 is mounted to the wall portion 27 from the side of the axially backward direction B. The intermediate portion 61 has a basic form shaped like a cylinder. As shown in FIGS. 1 and 2, the intermediate portion 61 is connected to the connecting portion 9 from the side of the axially forward direction F.

(1-4) Configuration of Connecting Portion 9

A configuration of the connecting portion 9 will be described based on FIGS. 1, 2, 15, and 22. The connecting portion 9 has a substantially L-shaped form. In the connecting portion 9, a base portion 63 located closer to the lock body 7 extends along the axially backward direction B. The base portion 63 has a form shaped like a cylinder. As shown in FIG. 22, a step 101 is formed on an inner peripheral surface of the base portion 63. The inside diameter in a part on the side of the axially forward direction F with respect to the step 101 is greater than the inside diameter in a part on the side of the axially backward direction B with respect to the step 101. As shown in FIG. 22, an O-ring 103 is inserted in the base portion 63. The O-ring 103 abuts the step 101 from the side of the axially forward direction F. As shown in FIGS. 1, 2, and 22, the base portion 63 is connected to the intermediate portion 61. The intermediate portion 61 is inserted into the base portion 63. A leading end of the intermediate portion 61 faces the O-ring 103. Positioning of the O-ring 103 is achieved by being arranged between the step 101 and the leading end of the intermediate portion 61. A leading end portion 65, which is on a leading end side of the connecting portion 9, extends in the downward direction D. When the first pipe 3 is connected to the connector 1, the leading end portion 23 is inserted into the O-ring 103 as shown in FIG. 22.

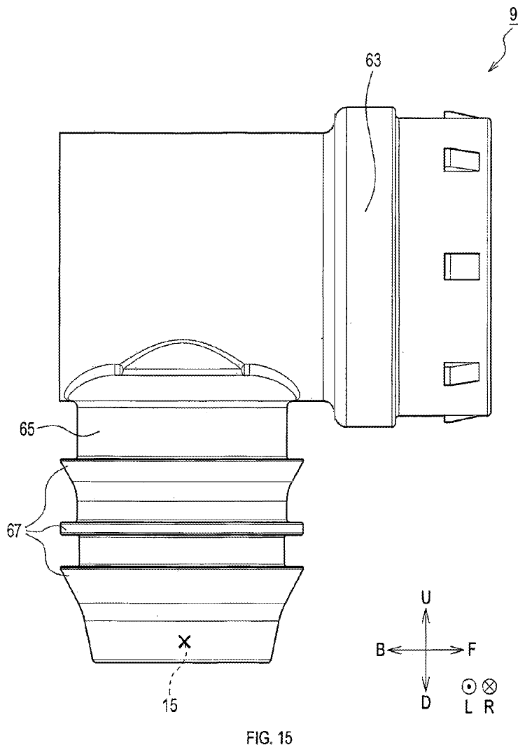

As shown in FIG. 2, the leading end portion 65 is inserted into the second pipe 5 from an end 5A of the second pipe 5. Insertion of the leading end portion 65 into the second pipe 5 causes the second pipe 5 to be connected to the connector 1. The leading end portion 65 includes an opening 15 at a leading end thereof. As shown in FIG. 15, a plurality of protrusions 67 each having an annular-ring-like shape are formed on an outer peripheral surface of the leading end portion 65. Provision of the plurality of protrusions 67 makes it difficult for the second pipe 5 to come off from the connecting portion 9.

(1-5) Configuration of Retainer 11

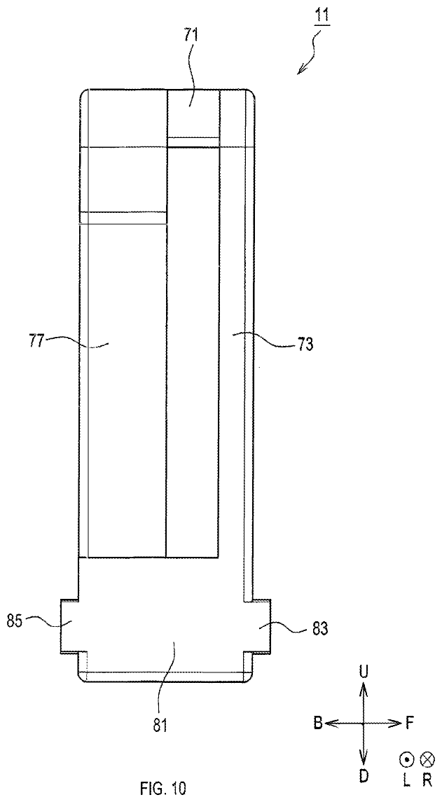

A configuration of the retainer 11 will be described based on FIGS. 10 to 14. A basic form of the retainer 11 is an inverted U-shape form. The retainer 11 comprises a base portion 71, locking legs 73, 75, and biasing legs 77, 79. The retainer 11 is made of an elastically deformable resin. The base portion 71 corresponds to a locking-legs connecting portion.

The base portion 71 is a rectangular plate-shaped member located on the side of the upward direction U in the retainer 11. The thickness direction of the base portion 71 is parallel to the upward direction U. Descriptions of the directions relating to the retainer 11 indicate the directions in the case where the retainer 11 is attached to the lock body 7.

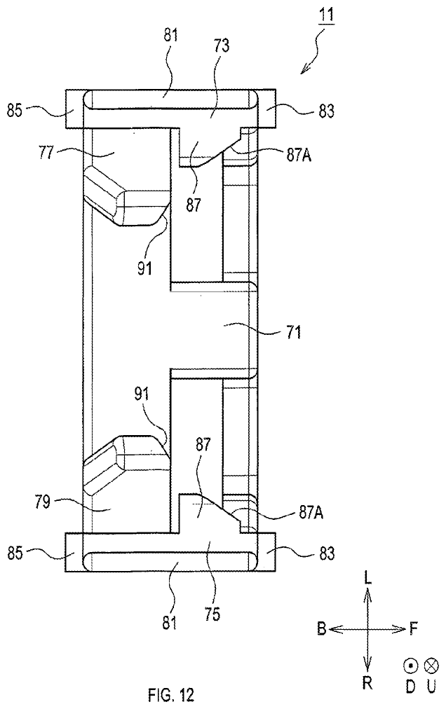

The locking leg 73 is connected to a part of the base portion 71 on the side of the axially forward direction F and also on the side of the leftward direction L. The locking leg 73 has a basic form shaped like an L. The locking leg 73 extends in the leftward direction L from the base portion 71, and further extends in the downward direction D. As shown in FIGS. 10 and 12, a lower end part 81 of the locking leg 73 has a form extending in the axially backward direction B. As shown in FIG. 10, when viewed from a viewpoint on the side of the leftward direction L, a part of the lower end part 81 is in a position overlapping with the biasing leg 77. The lower end part 81 is outside the biasing leg 77. The lower end part 81 is not in contact with the biasing leg 77, and is spaced therefrom.

As shown in FIGS. 10 to 12, the lower end part 81 has a protrusion 83 formed thereon on the side of the axially forward direction F. The protrusion 83 protrudes in the axially forward direction F. Also, the lower end part 81 has a protrusion 85 formed thereon on the side of the axially backward direction B. The protrusion 85 protrudes in the axially backward direction B.

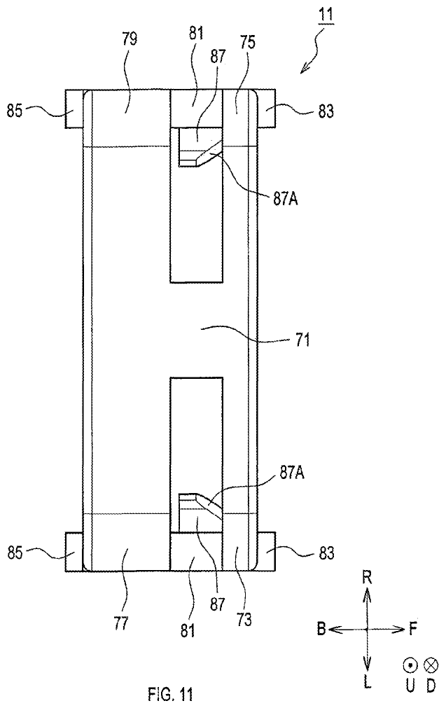

As shown in FIGS. 11 to 14, a beveled protrusion 87 is formed on an inner surface of the lower end part 81. The beveled protrusion 87 comprises an inclined surface 87A on the side of the axially forward direction F. The inclined surface 87A is inclined such that the height of the beveled protrusion 87 with respect to the lower end part 81 increases as proceeding in the axially backward direction B.

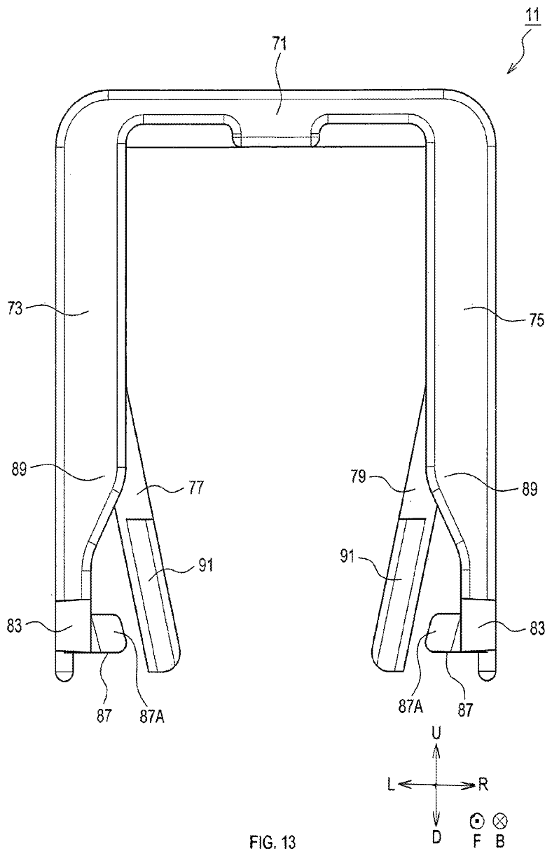

As shown in FIG. 13, a part of the locking leg 73 is a restraining part 89. The restraining part 89 has a function of restraining detachment of the first pipe 3 when the first pipe 3 is connected to the connector 1 and the retainer 11 is in a restraining position, which position will be described below, by contacting with the bulged portion 21 from the side of the axially forward direction F. The detachment of the first pipe 3 refers to the first pipe 3 being detached from the insertion hole 13. The details will be described below. The restraining part 89 is a member formed in one piece with the locking leg 73.

The locking leg 75 has a configuration similar to that of the locking leg 73. However, the orientation of the locking leg 75 is mirror-symmetrical to the orientation of the locking leg 73 with respect to a plane parallel to the upward direction U and perpendicular to the leftward direction L or the rightward direction R. Further, the locking leg 75 is connected to a part of the base portion 71 on the side of the axially forward direction F and also on the side of the rightward direction R. The locking leg 75 extends in the rightward direction R from the base portion 71, and further extends in the downward direction D. The protrusions 83, 85 provided to the locking legs 73, 75 correspond to a locking part.

The biasing leg 77 is connected to a part of the base portion 71 on the side of the axially backward direction B and also on the side of the leftward direction L. The biasing leg 77 has a substantially L-shaped basic form. The biasing leg 77 extends in the leftward direction L from the base portion 71, and further extends in an obliquely downward direction. The obliquely downward direction is a direction approaching the biasing leg 79 as proceeding in the downward direction D. The biasing leg 77 is located on the side of the axially backward direction B with respect to the locking leg 73. The biasing leg 77 is not in contact with the locking leg 73, and is spaced therefrom. As shown in FIGS. 12 and 13, a part of the biasing leg 77 on the side of the downward direction D and also on the side of the axially forward direction F is an inclined surface 91. As shown in FIG. 12, the inclined surface 91 is inclined such that the thickness of the biasing leg 77 gradually increases as proceeding in the axially backward direction B.

As shown in FIG. 13, when viewed from a viewpoint on the side of the axially forward direction F, the inclined surface 91 is inside the beveled protrusion 87. As will be described below, when the first pipe 3 is inserted into the insertion hole 13, the leading end portion 23 contacts with the inclined surface 91, but does not contact with the beveled protrusion 87. The bulged portion 21 contacts with the beveled protrusion 87.

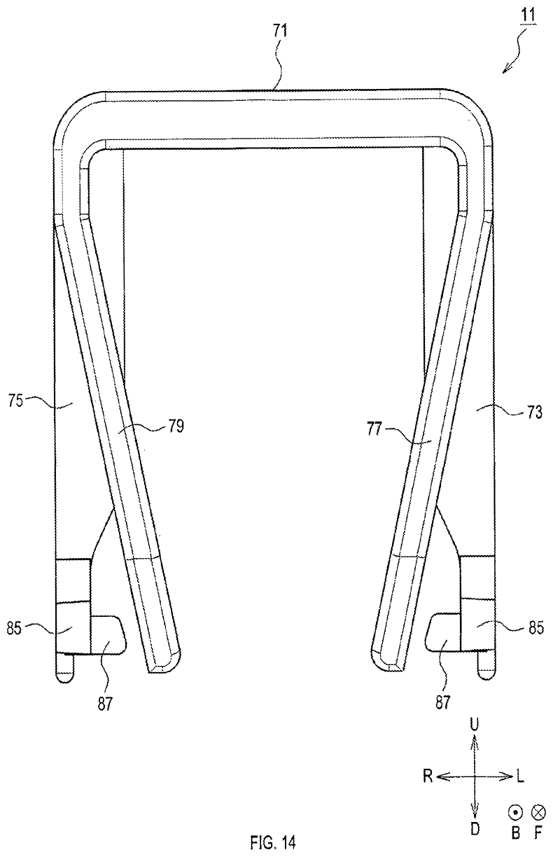

The biasing leg 79 has a configuration similar to that of the biasing leg 77. However, the orientation of the biasing leg 79 is mirror-symmetrical to the orientation of the biasing leg 77 with respect to the plane parallel to the upward direction U and perpendicular to the leftward direction L or the rightward direction R. Further, the biasing leg 79 is connected to a part of the base portion 71 on the side of the axially backward direction B and also on the side of the rightward direction R. The biasing leg 79 extends in the rightward direction R from the base portion 71, and further extends in an obliquely downward direction. The obliquely downward direction in the case of the biasing leg 79 is a direction approaching the biasing leg 77 as proceeding in the downward direction D. As shown in FIGS. 13 and 14, a distance between the biasing leg 77 and the biasing leg 79 is smaller as proceeding in the downward direction D.

### 2. Method of Using Connector 1

(2-1) Attachment of Retainer 11

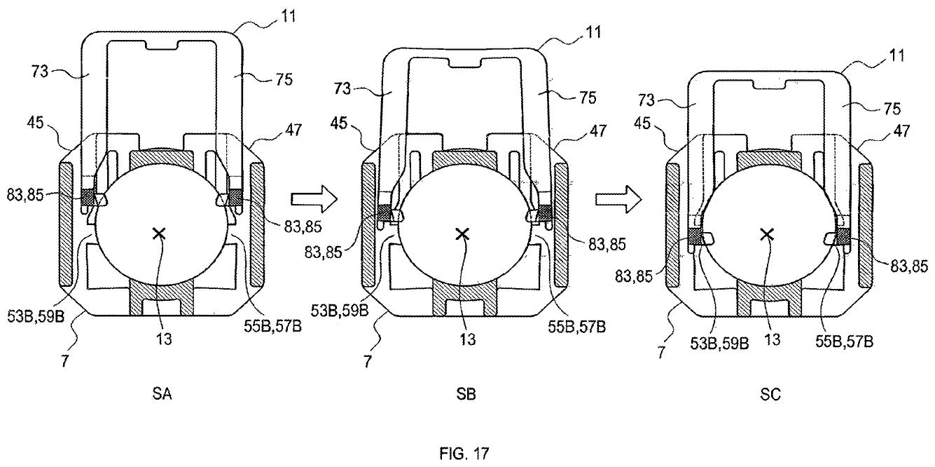

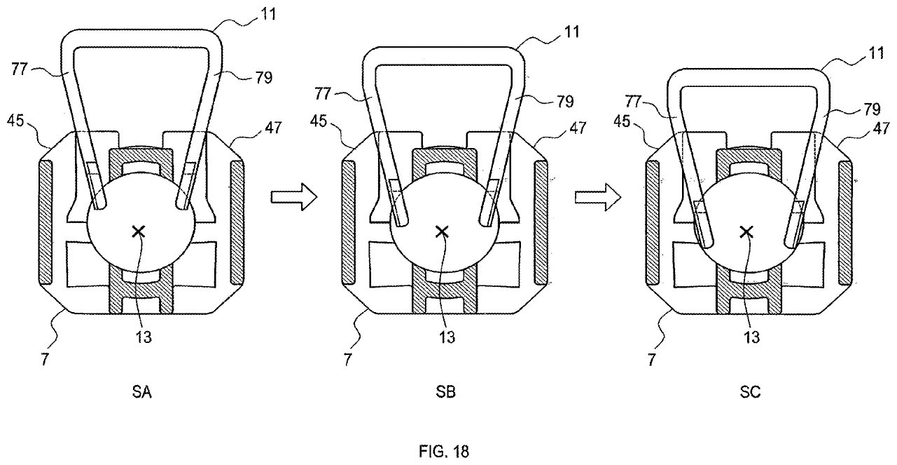

A method of using the connector 1 will be descried. First, a method of attaching the retainer 11 to the lock body 7 will be described based on FIGS. 17 and 18. The locking leg 73 and the biasing leg 77 are inserted into the opening 45 so as to bring about a state of SA shown in FIGS. 17 and 18. Also, the locking leg 75 and the biasing leg 79 are inserted into the opening 47.

At this time, the protrusion 83 on the locking leg 73 is inserted into the groove 59 shown in FIG. 4, and is guided by the groove 59. The protrusion 83 on the locking leg 73 is in contact with the edge part 59D. The protrusion 85 on the locking leg 73 is inserted into the groove 53 shown in FIG. 4, and is guided by the groove 53. The protrusion 85 on the locking leg 73 is in contact with the edge part 53D.

The protrusion 83 on the locking leg 75 is inserted into the groove 57 shown in FIG. 4, and is guided by the groove 57. The protrusion 83 on the locking leg 75 is in contact with the edge part 57D. The protrusion 85 on the locking leg 75 is inserted into the groove 55 shown in FIG. 4, and is guided by the groove 55. The protrusion 85 on the locking leg 75 is in contact with the edge part 55D.

Next, the retainer 11 is further pushed in in the downward direction D so as to bring about a state of SB shown in FIGS. 17 and 18. As shown in FIGS. 8 and 9, the edge parts 53D, 55D, 57D, 59D are displaced outward as proceeding in the downward direction D, and thus, as the retainer 11 advances in the downward direction D, the retainer 11 is elastically deformed such that the locking legs 73, 75 spread outward. “Outward” is the leftward direction L for the locking leg 73, and is the rightward direction R for the locking leg 75.

Furthermore, the retainer 11 is pushed in in the downward direction D so as to bring about a state of SC shown in FIGS. 17 and 18. The state of SC is a state where the retainer 11 is in a standby position. The standby position is a position in which the retainer 11 allows insertion of the first pipe 3 into the insertion hole 13 and detachment of the first pipe 3.

When in the standby position, the retainer 11 is locked to the lock body 7. In the standby position, the protrusion 83 on the locking leg 73 is locked by having entered the first body-side locking part 59B shown in FIG. 9. When the protrusion 83 on the locking leg 73 reaches the first body-side locking part 59B, a restoring force of the locking leg 73, which has been elastically deformed outward until now, causes the protrusion 83 on the locking leg 73 to enter the first body-side locking part 59B.

Similarly, in the standby position, the protrusion 85 on the locking leg 73 is locked by having entered the first body-side locking part 53B shown in FIG. 8. When the protrusion 85 on the locking leg 73 reaches the first body-side locking part 53B, the restoring force of the locking leg 73, which has been elastically deformed outward until now, causes the protrusion 85 on the locking leg 73 to enter the first body-side locking part 53B.

Similarly, in the standby position, the protrusion 83 on the locking leg 75 is locked by having entered the first body-side locking part 57B shown in FIG. 9. When the protrusion 83 on the locking leg 75 reaches the first body-side locking part 57B, a restoring force of the locking leg 75, which has been elastically deformed outward until now, causes the protrusion 83 on the locking leg 75 to enter the first body-side locking part 57B.

Similarly, in the standby position, the protrusion 85 on the locking leg 75 is locked by having entered the first body-side locking part 55B shown in FIG. 8. When the protrusion 85 on the locking leg 75 reaches the first body-side locking part 55B, the restoring force of the locking leg 75, which has been elastically deformed outward until now, causes the protrusion 85 on the locking leg 75 to enter the first body-side locking part 55B.

(2-2) Connection of First Pipe 3

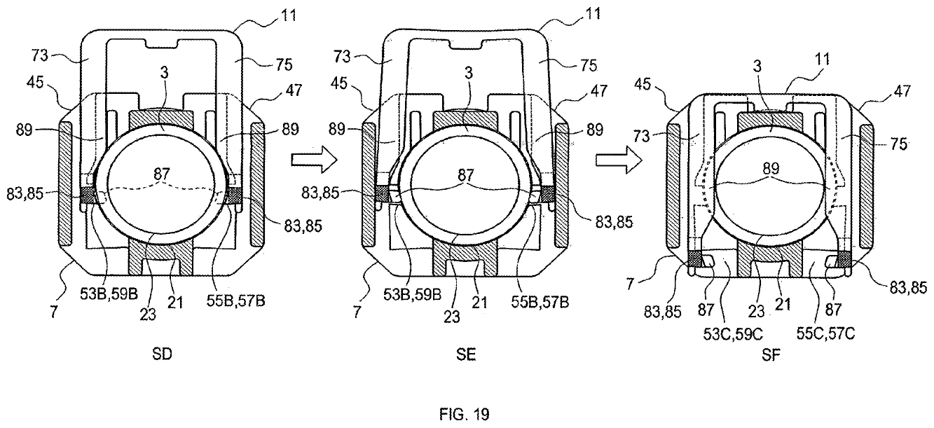

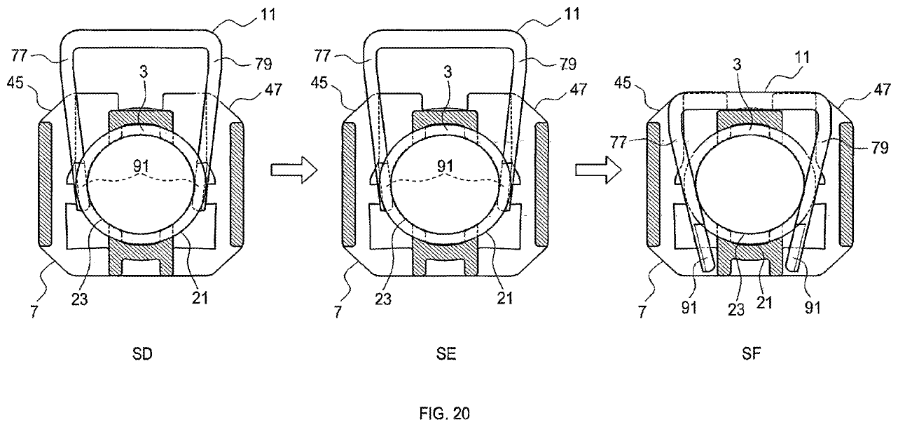

Next, a method of connecting the first pipe 3 to the connector 1 will be described based on FIGS. 19 and 20. The position of the retainer 11 is set to a standby state. The position of the first pipe 3 is set to be on the side of the axially forward direction F with respect to the connector 1. The orientation of the first pipe 3 is set such that the leading end 19 is on the side of the axially backward direction B. The first pipe 3 is moved in the axially backward direction B from the side of the axially forward direction F and inserted into the insertion hole 13, to thereby bring about a state of SD shown in FIGS. 19 and 20.

In the state of SD, the leading end portion 23 is in contact with the inclined surfaces 91 on the biasing legs 77, 79 shown in FIGS. 12 and 13, and pushes the inclined surfaces 91 in the axially backward direction B. The biasing legs 77, 79 are each elastically deformed outward in a radial direction of the leading end portion 23. In the biasing legs 77, 79, a restoring force attempting to be displaced inward in the radial direction of the leading end portion 23 is generated. The biasing legs 77, 79 apply the restoring force to an outer peripheral surface of the leading end portion 23, and receive a reaction force from the outer peripheral surface of the leading end portion 23. Since parts where the biasing legs 77, 79 are in contact with the leading end portion 23 are located on the side of the downward direction D with respect to the central axis of the leading end portion 23, the reaction force received by the biasing legs 77, 79 includes a component directed in the downward direction D. As a result, the retainer 11 is biased in the downward direction D. The downward direction D is a direction toward the restraining position, which will be described below.

In the state of SD, the leading end portion 23 is not in contact with the locking legs 73, 75. Also, in the state of SD, the bulged portion 21 is located on the side of the axially forward direction F with respect to the locking legs 73, 75, and is yet to come in contact with the locking legs 73, 75.

When the first pipe 3 is further moved in the axially backward direction B, a state of SE is brought about. In the state of SE, the bulged portion 21 is in contact with the inclined surfaces 87A on the locking legs 73, 75 shown in FIG. 13, and pushes the inclined surfaces 87A in the axially backward direction B. The locking legs 73, 75 each begin to be elastically deformed outward in a radial direction of the bulged portion 21. In the state of SE too, the biasing legs 77, 79 bias the retainer 11 in the downward direction D.

When the first pipe 3 is further moved in the axially backward direction B, the locking legs 73, 75 are each further elastically deformed outward in the radial direction of the bulged portion 21, and the protrusion 83 on the locking leg 73 comes off from the first body-side locking part 59B, and the protrusion 85 on the locking leg 73 comes off from the first body-side locking part 53B. Also, the protrusion 83 on the locking leg 75 comes off from the first body-side locking part 57B, and the protrusion 85 on the locking leg 75 comes off from the first body-side locking part 55B. That is, locking of the protrusions 83, 85 of the locking legs 73, 75 is released.

When locking of the protrusions 83, 85 of the locking legs 73, 75 is released, the retainer 11 is moved in the downward direction D because the retainer 11 is biased in the downward direction D, and a state of SF shown in FIGS. 19 and 20 is brought about. The state of SF is a state where the retainer 11 is in the restraining position. The restraining position is a position in which the retainer 11 restrains detachment of the connected first pipe 3.

In the restraining position, the protrusion 83 on the locking leg 73 is locked by having entered the second body-side locking part 59C shown in FIG. 9. When the protrusion 83 on the locking leg 73 reaches the second body-side locking part 59C, the restoring force of the locking leg 73, which has been elastically deformed outward until now, causes the protrusion 83 on the locking leg 73 to enter the second body-side locking part 59C.

Similarly, in the restraining position, the protrusion 85 on the locking leg 73 is locked by having entered the second body-side locking part 53C shown in FIG. 8. When the protrusion 85 on the locking leg 73 reaches the second body-side locking part 53C, the restoring force of the locking leg 73, which has been elastically deformed outward until now, causes the protrusion 85 on the locking leg 73 to enter the second body-side locking part 53C.

Similarly, in the restraining position, the protrusion 83 on the locking leg 75 is locked by having entered the second body-side locking part 57C shown in FIG. 9. When the protrusion 83 on the locking leg 75 reaches the second body-side locking part 57C, the restoring force of the locking leg 75, which has been elastically deformed outward until now, causes the protrusion 83 on the locking leg 75 to enter the second body-side locking part 57C.

Similarly, in the restraining position, the protrusion 85 on the locking leg 75 is locked by having entered the second body-side locking part 55C shown in FIG. 8. When the protrusion 85 on the locking leg 75 reaches the second body-side locking part 55C, the restoring force of the locking leg 75, which has been elastically deformed outward until now, causes the protrusion 85 on the locking leg 75 to enter the second body-side locking part 55C.

When the retainer 11 is in the restraining position, the bulged portion 21 is in contact with the ribs 42, 44 shown in FIGS. 5, 6, and 22. Such contact of the bulged portion 21 with the ribs 42, 44 results in positioning of the first pipe 3. As shown in FIG. 2, when the retainer 11 is in the restraining position, the bulged portion 21 is located on the side of the axially backward direction B with respect to the locking leg 73. The restraining part 89 of the locking leg 73 is in contact with the bulged portion 21 from the side of the axially forward direction F, to thereby restrain detachment of the first pipe 3. The restraining part 89 of the locking leg 75 also comes in contact with the bulged portion 21 from the side of the axially forward direction F, to thereby restrain detachment of the first pipe 3.

When the retainer 11 is in the restraining position, the wall portion 25 is in contact with the locking legs 73, 75 from the side of the axially forward direction F. Thus, even when a force in the axially forward direction F is applied to the connected first pipe 3, the locking legs 73, 75 are less likely to be deformed because they are supported by the wall portion 25.

As shown in FIG. 2, when the retainer 11 is in the restraining position, the biasing leg 77 is present spaced from the bulged portion 21 by a small gap present on the side of the axially backward direction B of the bulged portion 21. The biasing leg 79 is also present spaced from the bulged portion 21 by a small gap present on the side of the axially backward direction B of the bulged portion 21.

### 3. Effects Produced by Connector 1

(1A) When the first pipe 3 is inserted into the insertion hole 13, the state of the connector 1 is changed in order of SD, SE, and SF. The connector 1 is configured such that the retainer 11 is biased in the downward direction D from when it is in the state of SD up to when it is in the state of SF. The connector 1 is configured such that, in the state in which the retainer 11 is biased in the downward direction D, locking of the protrusions 83, 85 of the locking legs 73, 75 is released to cause the retainer 11 to move to the restraining position. Thus, when the first pipe 3 is connected to the connector 1, the retainer 11 is easily moved to the restraining position.

(1B) The restraining parts 89 each are a member formed in one piece with a corresponding one of the locking legs 73, 75. Thus, the structure of the connector 1 can be simplified.

(1C) The lock body 7 comprises the first body-side locking parts 53B, 55B, 57B, 59B. The first body-side locking parts 53B, 55B, 57B, 59B lock the protrusions 83, 85 of the locking legs 73, 75 when the retainer 11 is in the standby position.

The lock body 7 comprises the second body-side locking parts 53C, 55C, 57C, 59C. The second body-side locking parts 53C, 55C, 57C, 59C lock the protrusions 83, 85 of the locking legs 73, 75 when the retainer 11 is in the restraining position. Thus, the connector 1 allows for reliable locking of the retainer 11 in the standby position and in the restraining position.

### Second Embodiment

### 1. Differences from First Embodiment

A basic configuration of a second embodiment is similar to that of the first embodiment; thus, differences therefrom will be described below. The same reference numerals as in the first embodiment indicate the same elements, and the preceding descriptions are to be referred to.

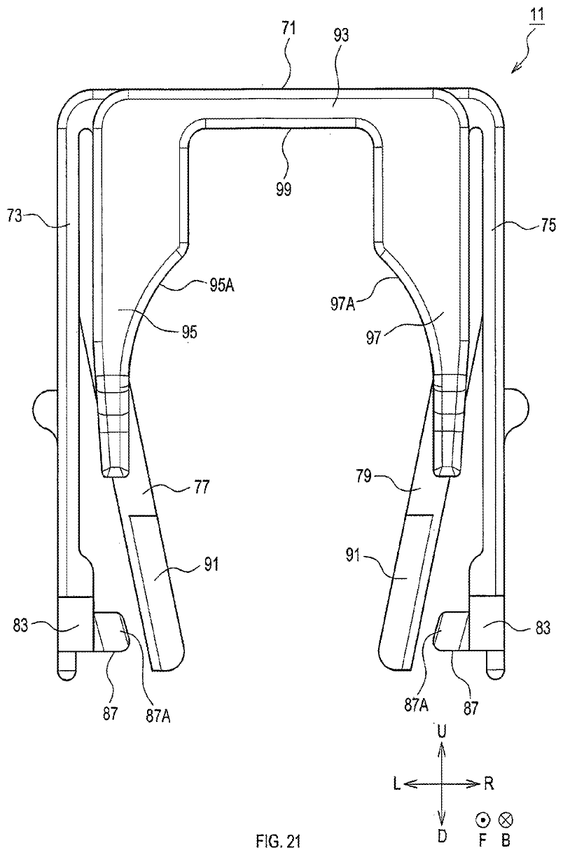

In the above-described first embodiment, the retainer 11 has the form shown in FIGS. 10 to 14. In contrast, in the second embodiment, the retainer 11 has a form shown in FIG. 21. This is a difference from the first embodiment.

The retainer 11 further comprises a restraining plate 93. The restraining plate 93 is a plate-shaped member extending in the downward direction D from a part of the base portion 71 on the side of the axially forward direction F. The restraining plate 93 comprises restraining parts 95, 97 and a central part 99.

The restraining part 95 is located closer to the locking leg 73, and extends in the downward direction D. A shape of an end face 95A on the inside of the restraining part 95 is an arc shape. The restraining part 97 is located closer to the locking leg 75, and extends in the downward direction D. A shape of an end face 97A on the inside of the restraining part 97 is an arc shape.

The central part 99 is located between the restraining part 95 and the restraining part 97. The central part 99 is a part having a smaller vertical width than the restraining parts 95, 97. The central part 99 is a part elastically deformed more easily than other parts in the base portion 71 and the restraining part 95 when the bulged portion 21 pushes the inclined surface 87A in the axially forward direction F. The base portion 71 and the restraining part 95 correspond to a locking-legs connecting portion.

The restraining parts 95, 97 have a function of restraining detachment of the first pipe 3 when the first pipe 3 is connected to the connector 1 and the retainer 11 is in the restraining position, by contacting with the bulged portion 21 from the side of the axially forward direction F. The locking legs 73, 75 do not comprise the restraining parts 89 of the first embodiment.

### 2. Effects Produced by Connector 1

The second embodiment detailed so far produces the effects (1A) and (1C) of the above-described first embodiment, and further produces the following effect.

(2A) The retainer 11 comprises the central part 99. The central part 99 is a part having a smaller vertical width. Thus, when the bulged portion 21 comes in contact with the locking legs 73, 75, the retainer 11 is elastically deformed easily at the central part 99, and the locking legs 73, 75 are displaced outward. As a result, the connector 1 can be easily shifted from the state of SA to the state of SC in FIGS. 17 and 18. Further, the connector 1 can be easily shifted from the state of SD to the state of SF in FIGS. 19 and 20.

### Other Embodiments

The embodiments of the present disclosure have been described so far; however, the present disclosure can be practiced in variously modified forms without being limited to the above-described embodiments.

(1) The function of a single element in each of the above-described embodiments may be performed by two or more elements, and the function performed by two or more elements may be performed by a single element. Part of the configuration in each of the above-described embodiments may be omitted. At least part of the configuration in each of the above-described embodiments may be added to or replace another configuration in the above-described embodiments.

(2) In addition to the above-described connector 1, the present disclosure can also be implemented in various forms, such as a system including the connector 1 as an element, and a method for manufacturing the connector 1.

1. A connector comprising:
a connector body; and
a retainer,
the connector being configured to be connected to a first pipe comprising a bulged portion and to a second pipe,
the connector body comprising:
an insertion hole into which the first pipe is inserted from one side; and
an opening communicating with the insertion hole,
the retainer being configured to be movable between a standby position in which the first pipe is allowed to be inserted into the insertion hole and to be detached from the insertion hole and a restraining position in which the first pipe connected is restrained from being detached from the insertion hole,
the retainer comprising:
a locking leg to be inserted inside the connector body through the opening;
a biasing leg to be inserted inside the connector body through the opening; and
a restraining part configured to, when the first pipe is connected to the connector and the retainer is in the restraining position, restrain detachment of the first pipe from the insertion hole by contacting with the bulged portion from the one side,
the locking leg comprising a locking part to be locked to the connector body when the retainer is in the standby position and when the retainer is in the restraining position,
the locking leg being configured to, when the retainer is in the standby position and the first pipe is inserted into the insertion hole, move outward in a radial direction of the first pipe by contacting with the bulged portion, to thereby release locking of the locking part, and
the biasing leg being configured to, when the retainer is in the standby position and the first pipe is inserted into the insertion hole, be elastically deformed outward in the radial direction of the first pipe by contacting with a leading end portion of the first pipe, which is located on a leading end side with respect to the bulged portion, before the locking leg comes in contact with the bulged portion, to thereby bias the retainer in a direction toward the restraining position.

2. The connector according to claim 1,
wherein the locking leg and the restraining part constitute a one-piece member.

3. The connector according to claim 1,
wherein the connector body further comprises:
a first body-side locking part configured to lock the locking part when the retainer is in the standby position; and
a second body-side locking part configured to lock the locking part when the retainer is in the restraining position.

4. The connector according to claim 1,
wherein the retainer further comprises a locking-legs connecting portion connecting the locking leg and another locking leg to each other, and
wherein a part of the locking-legs connecting portion is elastically deformed more easily than a part other than the part of the locking-legs connecting portion when the bulged portion comes in contact with the locking leg.

5. The connector according to claim 2,
wherein the connector body further comprises:
a first body-side locking part configured to lock the locking part when the retainer is in the standby position; and
a second body-side locking part configured to lock the locking part when the retainer is in the restraining position.

6. The connector according to claim 2,
wherein the retainer further comprises a locking-legs connecting portion connecting the locking leg and another locking leg to each other, and
wherein a part of the locking-legs connecting portion is elastically deformed more easily than a part other than the part of the locking-legs connecting portion when the bulged portion comes in contact with the locking leg.

7. The connector according to claim 3,
wherein the retainer further comprises a locking-legs connecting portion connecting the locking leg and another locking leg to each other, and
wherein a part of the locking-legs connecting portion is elastically deformed more easily than a part other than the part of the locking-legs connecting portion when the bulged portion comes in contact with the locking leg.

8. The connector according to claim 5,
wherein the retainer further comprises a locking-legs connecting portion connecting the locking leg and another locking leg to each other, and
wherein a part of the locking-legs connecting portion is elastically deformed more easily than a part other than the part of the locking-legs connecting portion when the bulged portion comes in contact with the locking leg.
